(19) United States
(12) Patent Application Publication
(10) Pub. No.: US 2003/0143367 A1
(43) Pub. Date: Jul. 31, 2003

(54) Protective and/or decorative mat for equipping a motor vehicle

(76) Inventor: Thierry Room, Valenciennes (FR)

Correspondence Address: Harrison & Egbert, 412 Main Street 7th Floor, Houston, TX, 77002, US

(21) Appl. No.: 10/297,513

(22) PCT Filed: May 31, 2001
(86) PCT No.: PCT/FR01/01688

(30) Foreign Application Priority Data
Jun. 9, 2000 (FR) 00-07412
Sep. 8, 2000 (FR) 00/11489

(51) Int. Cl. B32B 33/00; B32B 3/02

(52) U.S. Cl. 428/82; 428/95; 428/88; 83/13

(57) ABSTRACT

A protective and/or decorative mat, in particular for equipping a motor vehicle, and a method for making such a mat. The mat includes a multilayer structure having an upper surface, in particular, covered with a textile coating, and a lower surface, designed to be placed in contact with the mat laying plane. The invention is characterized in that the lower surface includes a layer of material having a high friction coefficient.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns a protection and/or decoration carpet, notably intended to equip an automotive vehicle.

### BACKGROUND OF THE INVENTION

In this field, although the automotive manufacturers cover the floor of vehicles with a carpet which is more or less heavy duty, the driver often buys additional protection and/or decoration carpets. Such carpets are, as the case may be, more or less suited to the layout of the floor of the vehicle, and overlay those mounted originally.

Such carpets are generally composed of pieces out according to a preset contour and then oversewn. Similarly, the floor of the vehicle is, by construction, generally covered with a carpet which is more or less enriched.

It is then that one encounters a shortcoming inherent to the superimposition of the carpet on the floor of the vehicle. Indeed, it is current that when one lays a carpet on another area of same type, the covering carpet slips over the original carpet, which causes on the one hand interstices wherein dusts and pebbles will accumulate, going as far as, on the other hand, to disturb the correct operation of the control pedals of the vehicle.

To remedy these shortcomings, various hooking or stapling devices are known, composed of screw-type systems going through the carpet of the vehicle or hook system which grab, on the one hand, the internal carpet and, on the other hand, the external face of the floor to be fitted.

However, such devices cause deterioration of the floor of the vehicle, further to the necessary hooking operations, which scares off a large number of users. Moreover, the link is punctual and proves little efficient in the long run, taking into account the stresses generated by the user.

One also has the realization of preformed carpets, in the form of a tub suited to the floor to be fitted. If keeping such preformed carpets in place is more efficient, such realizations are penalized by a larger cost price and by the requirement of a greater storage surface taking into account the volume of the carpets.

Other solutions have also been contemplated to attempt locking the carpet on its laying plane, while using various rigid performs, with a view to blocking the carpet at its contour. Nevertheless, such devices enjoy certain transversal efficiency, but one also finds a longitudinal sliding motion, notably at the driver's level taking into account the movement of his feet.

The purpose of this invention is to suggest a protection and/or decoration carpet, notably intended to equip a vehicle, which enables to remedy the shortcomings mentioned above while providing good handling, without slipping, of the carpet on its laying plane.

Another purpose of this invention is to suggest a method of manufacturing of such a protection and/or decoration carpet that is totally in harmony with the industrial manufacturing conditions and in particular in-line manufacturing conditions.

Another purpose of this invention is to suggest a protection and/or decoration carpet keeping the advantages of the non-rigid flat carpets while solving the shortcoming due to slippage.

Another purpose of this invention is to suggest a protection and/or decoration carpet as well as a manufacturing process, which remain economically in order not to penalize the cost of the finished product, and whereof the implementation is easy, for manufacturing as well as usage.

Other objects and advantages of this invention will appear during the following description, which is however given for exemplification purposes and which does aim at limiting said invention.

### BRIEF SUMMARY OF THE INVENTION

According to the invention, the protection and/or decoration carpet, notably intended to equip a vehicle composed of a multilayer structure exhibiting an upper face, notably covered by a textile lining, and a lower face, intended to be placed in contact with the laying plane of the carpet, is characterized in that said lower face comprises a layer of material exhibiting high friction coefficient.

The manufacturing process of the protection and/or decoration carpet, according to the invention, is characterized in that:

one superimposes a supporting sheet covered notably with a textile lining, and a layer of material exhibiting high friction coefficient, and

one cuts simultaneously said supporting sheet and said layer of material, according to the contour of the carpet to provide.

### BRIEF DESCRIPTION OF THE SEVERAL VIEWS OF THE DRAWINGS

This invention will be understood better when reading the following description together with the appended drawings wherein:

FIG. 1 shows a front schematic view of a carpet according to this invention.

FIG. 2 shows a view from beneath of the carpet represented an FIG. 1,

FIG. 3 shows a partial sectional view of the carpet along the axis III-III of FIG. 1.

FIG. 4 illustrates schematically the manufacturing process of the carpet according to the invention.

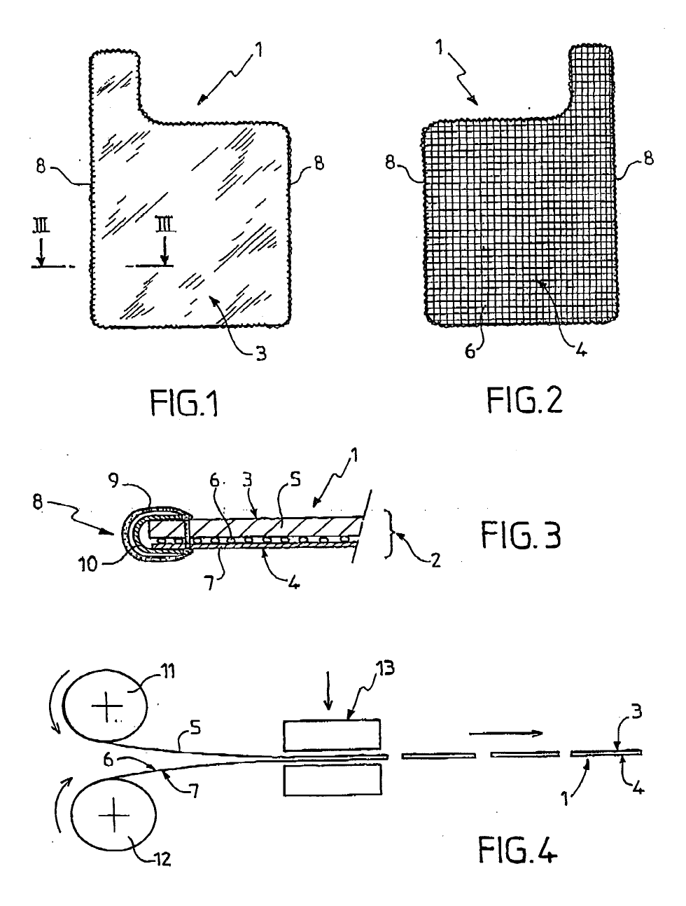

### DETAILED DESCRIPTION OF THE INVENTION

This invention concerns a protection and/or decoration carpet, notably intended to equip an automotive vehicle.

Although developed more particularly within this framework, this invention is not limited however to this field, and could be perfectly applied more generally to all the fields wherein one will be faced with the superimposition of two carpets according to the same criteria.

As suggested on the figures, the protection and/or decoration carpet 1 is of the flexible flat type carpet in order to be exhibited for sale within minimum volume, and to be adapted to the different variations of the vehicle floor. However, it should be noted first and foremost that this invention could be explained within the framework of a rigid carpet, possibly of the preformed type.

Similarly, the contour of the carpet illustrated on the figures is not limitative in any way, and this invention can be suited to all shapes of carpets, the driver's carpet or the front passenger's carpet as well as carpets intended to equip the rear of the vehicle.

Finally, the application of the vehicle should not be construed as a limitative application and the invention could be applied to all types of household carpets, for example.

Having said that, the carpet 1 is composed of a multilayer structure 2 exhibiting an upper face 3 and a lower face 4.

By upper face 3 is meant the face which will be intended for usage for said protection and/or decoration. In the case of an automotive vehicle, it is this upper face which will be subject to the continuous pressure of the users'feet,

This upper face 3 is composed, in a known fashion, of a supporting sheet 5, for example made of a synthetic or fibrous material, covered notably with a textile lining, such as notably velvet or a needled or tufted element.

Besides, by lower face 4 is meant the face intended to be placed in contact with the laying plane of the carpet, which in the case of the automotive vehicle, will be notably composed of the floor covered, at least partially, with its carpet.

According to this invention, this lower face 4 comprises a layer of material 6 exhibiting high friction coefficient.

Thus, thanks to the presence of this layer, there will be perfect adhesion of the protection and/or decoration carpet to the laying plane, regardless of the nature of the latter. The high friction coefficient should prevent both opposite faces from slipping away from one another, without however causing any damages of the laying plane and of gluing dirty particles of the latter.

According to a first embodiment of this invention, said layer 6 making up the lower face of the multilayer structure 2, has the shape of a sheet covering, in whole or in part, said multilayer structure.

In whole or in part means that said layer 6 of the lower face exhibits a face corresponding to that of the supporting sheet 5 of the upper face, or a lower face. Nevertheless, to provide good results, a 75%-percentage at least proves advantageous.

According to another embodiment of this invention, said layer 6 forming the lower face 4 of the multilayer structure 2 is in the form of a mesh covering, in whole in or part, said multilayer structure.

Said mesh can be composed of a net or similar. Indeed, according to another embodiment. said layer 6 can be in the form of one or several zones, independent or not linked to one another, such as for example a set of pins or other elements, more or less spaced and distributed, provided, directly or indirectly, at said lower face 4, under the supporting sheet 5, whereas such pins or elements have said high friction coefficient required.

Consequently, said layer of material 6 with high friction coefficient is based upon latex, rubber or similar, natural or synthetic. These materials have high friction properties and cause high adhesion, without being sticky, in the proper meaning.

Said layer of material 6 could also be, for example, composed of so-called re-positionable glue, i.e. of an adhesive material with high tensile strength to a load tangential to its plane of application and low tensile strength to a load perpendicular to its plane of application. Such a material, known incidentally, will have the advantage of not building up on the floor of the vehicle when the protection and/or decoration carpet is placed thereon,

Naturally, the arrangements described previously can be combined together and for example said meshing can be made of latex yarns or of textile yarns coated with so-called re-positionable glue. Similarly, said layer of material 6 can be for example composed of total or partial coating of the lower face of the latex support 5 or similar or of re-positionable glue.

According to another advantageous feature of this invention, said layer 6 based on latex, rubber, similar or other is fitted, as shown particularly on FIG. 3, prior to using the carpet 1, by a protection film 7. Said film will exhibit the advantages inherent to such protection films, but will also make the manufacturing of the carpet easier, as will appear further down in the description.

According to another advantageous feature of this invention, the selvedge 8 of the carpet 1 is fitted with an overedge 9 and/or a peripheral loop 10 for finishing the carpet and for blocking said material layer 6 exhibiting high friction coefficient and/or said protection film 7.

Thus, said supporting sheet 7, layer 6 and film 7 exhibiting identical contours, and the realization of said overedge, 9 forms, as developed below, means for interconnecting the three elements together, notably.

Similarly, the selvedge 8 of the carpet can be equipped with the peripheral loop 10 which surrounds, at that level, the supporting sheet 5, said layer 6 and the film 7 and interconnects these three elements.

Besides, according to another arrangement, the loop 10 can be covered by said peripheral overedge 9, which will enable to increase the finishing quality of the selvedge and to enhance its resistance.

Another function of the loop will also consist in blocking the periphery of said layer 6, and in the case of a meshing notably, in preventing the various sides of said meshing from going through the overedge.

As regards said meshing forming the layer 6 based on latex, rubber or similar, natural or synthetic, it will be formed advantageously by sides of a diameter ranging between 0.5 mm and 2 mm spaced apart by a pitch from 5 mm to 30 mm, according to a square or rectangular mesh, notably.

This meshing forms a flexible and soft net, without any intrinsic rigidity. It is thus that it will be advantageously arranged originally on said protection film 7, formed itself for example of a PVC plastic sheet or other conferring to the assembly certain rigidity necessary to its handling and its implementation.

In this view, FIG. 4 shows schematically a manufacturing process of the carpet according to this invention, authorizing on-line manufacture, among others. A coil 11 formed by winding said supporting sheet 5, covered notably with a textile lining, such as for example velvet or a needled or tufted element, is arranged.

A coil 12 formed by winding said layer 6 of material with high coefficient, previously coated on said protection film 7, is arranged.

Then the supporting sheet 5 and said layer 6, notably provided on the protection film 7, are superimposed and the different elements are brought closer to one another so that the supporting sheet 5 contacts said layer 6.

Then, said supporting sheet 5 and said layer of material 6 are cut simultaneously, along the contour of the carpet to be provided, notably in a cutting station, known as such, marked as 13 on FIG. 4.

Upon completion of the cutting operation, said supporting sheet 5, layer of material 6 and protection film 7 are interconnected by a peripheral overedge 9, as described previously against FIG. 3.

It should be noted here that the number of overedge stitches will be advantageously adapted to punch said protection film 7 with a view to tearing it off prior to using the carpet 1. Similarly, a compromise will be sought between this number of stitches and the thickness of the film 7 to make this peripheral tearing easier.

According to the satisfactory embodiment, one has obtained good results with a number of overedge stitches ranging between 3 and 6 per centimeter with a PVC plastic sheet 7 with a minimum thickness of 50 μm.

Naturally, other embodiments of this invention, known to the man of the art, could have been contemplated, without departing from the framework of said invention.

I claim:

1. A protection and/or decoration carpet (1), notably intended to equip a vehicle, composed of a multilayer structure (2) exhibiting an upper face (3), notably covered by a textile lining, and a lower face (4), intended to be placed in contact with the laying plane of the carpet, characterized in that said lower face (4) comprises a layer of material (6), in the form of a mash, covering, in whole or in part, said multilayer structure (2) and exhibiting high friction coefficient.

2. A carpet according to claim 1, wherein said layer (6) of the lower face is based on latex, rubber or similar, natural or synthetic, possibly so-called repositionable glue.

3. A carpet according to claim 1, wherein said layer (6) of the lower face is fitted, prior to using the carpet, with a protection film (7).

4. A carpet according to claim 3, wherein the selvedge (8) of the carpet (1) is fitted with a selvedge (9) and/or a peripheral loop (10) for finishing the carpet and blocking said layer of material (6) and/or of the protection film (7),

5. A carpet according to claim 4, wherein the selvedge (8) of the carpet (1) is fitted with a peripheral loop (10), capable of being covered with said peripheral overedge (9).

6. A manufacturing process of a protection and/or decoration carpet, formed by a multilayer structure exhibiting at least one supporting sheet, notably covered with a textile lining, according to claim 1, characterized in that
one superimposes a supporting sheet covered notably with a textile lining, and a layer of material exhibiting high friction coefficient,
one cuts simultaneously said supporting sheet and said layer of material, according to the contour of the carpet to provide.

7. A process according to claim 6, wherein, during said superimposition, said layer of material is provided on a protection film.

8. A process according to claim 7, wherein said supporting sheet, layer of material and protection film are interconnected by a peripheral overedge whereof the number of overedge stitches is adapted to punch sold protection film with a view to tearing it off prior to using the carpet.
